(19) United States
(12) Patent Application Publication
(10) Pub. No.: US 2006/0224875 A1
(43) Pub. Date: Oct. 5, 2006

(54) Portable digital player

(76) Inventors: Young-Joon Choi, Gyeonggi-do (KR); Jae-Sung Jung, Seoul (KR); Andy Yang, San Ramon, CA (US); Ivan K. Greenberg, San Jose, CA (US)

Correspondence Address: MARGER JOHNSON & MCCOLLOM, P.C., 210 SW MORRISON STREET, SUITE 400, PORTLAND, OR, 97204, US

(21) Appl. No.: 11/324,024

(22) Filed: Dec. 29, 2005

Related U.S. Application Data
(60) Provisional application No. 60/660,757, filed on Mar. 11, 2005.

(51) Int. Cl. G06F 1/00

(52) U.S. Cl. 713/1; 713/300

(57) ABSTRACT

A portable player may include a control unit designed to perform an instant replay operation using instant replay data stored in a nonvolatile semiconductor memory during a cold boot operation. The control unit may be designed to perform the instant replay operation without accessing a mechanical mass storage device during the cold boot operation, and the instant replay data may be loaded from a volatile work memory to the nonvolatile semiconductor memory during a power-down conversion.

This application claims priority from Provisional U.S. Application No. 60/660,757, filed on Mar. 11, 2005, now pending, the contents of which are herein incorporated by reference in their entirety.

### BACKGROUND

FIG. 1 schematically shows a conventional audio/video digital player. Referring to FIG. 1, the conventional audio/video digital player 1 is based on a hard disk drive (HDD) 11. Audio/video data to be replayed (e.g., audio and video files) is stored in the HDD 11. The player of FIG. 1 further includes a NOR-type flash memory 12 and a dynamic random access memory (DRAM) 13. The NOR-type flash memory 12 is used to store code such as boot code and an application program, and the DRAM is used as a work memory. The player of FIG. 1 is a portable player, and is driven by power supplied from a battery 14 embedded therein. The player of FIG. 1 further includes an audio controller 15 connected to an external microphone and speaker, a decoder 16, a user interface such as a display, and a USB interface 18 for interfacing with a host.

Hereinafter, the operation of the player 1 shown in FIG. 1 will be more fully described referring to FIGS. 2 and 3.

A microprocessor unit (MPU) or microcontroller unit (MCU) 19 performs a boot operation using boot code stored in the NOR-type flash memory 12 during power-up. Then, a hardware initialization operation is performed under the control of the MPU or MCU 19 (S30). After the hardware initialization operation is completed, the HDD 11 is initialized (S40). That is, a spin-up operation of the HDD 11 is performed. In the next step (S50), the initialization operations of a file system and software are performed (S60). Finally, replay data (data replayed previously or to be newly replayed) is loaded from the HDD 11 to the DRAM 13 under the control pf the MCU or MPU 19.

The player temporarily stores part of the data to be replayed (that is, an audio/video file) in the RAM 13 so as to minimize delay due to the spin-up operation of the HDD 11. A fixed region of the RAM where the part of the data to be replayed is called a playback buffer region. After the power-up period, the player enters a slip mode in which the replay operation is stopped. To minimize power consumption, power is supplied only to the DRAM and none of the other elements during slip mode. If the player transitions from slip mode to normal operation at the request of a user, replay operation resumes using replay data stored in the playback buffer region. This type of replay operation is called a warm boot operation.

If there is no input after a certain time during slip mode, the player transitions from slip mode to a power-down mode. If the player is continuously maintained in slip mode (that is, that state in which power is supplied to only to the DRAM), power is continuously consumed by the DRAM 13 (e.g., because of the DRAM's internal refresh operations). As such, the player 1 automatically enters power-down mode after a predetermined time in slip mode. If a slip-to-power-down conversion function is not provided, player continuously consumes power, so the run time of the battery 14 is reduced. Once the player enters power-down mode, power consumption stops. However, since power to the DRAM 13 is interrupted during power-down mode, all information stored in the DRAM is lost. If power is switched on by a user during power-down mode, the player must perform a cold boot operation including steps (S10) through (S60) as shown in FIG. 3.

Conventional portable audio/video players generally support an instant replay function in which final replay data, that is, the last replay data that was replayed in normal mode, is replayed again during a warm/cold boot operation. However, a large capacity DRAM is needed to support a playback buffer function (to minimize HDD operation). In addition, large amounts of power are consumed by DRAM self-refresh operation during slip mode. Furthermore, high-cost NOR-type flash memory is used to store boot code and an application program. A cold boot operation consumes large amounts of power and time to prepare a replay operation. This will be more fully described as follows.

A cold boot operation, as previously mentioned, is performed during steps (S20) through (S60) of FIG. 3. Specifically, as is well known, large amounts of time and power are consumed during a data copy operation for a HDD spin-up operation and for constructing a playback buffer by moving replay data from the HDD to the DRAM. Also, data to be replayed should be loaded from the HDD 11 to the playback buffer region of the DRAM 13 again in order to provide the instant replay function. Accordingly, high power consumption and long wait times for instant replay are problems in conventional players.

### SUMMARY

In one example embodiment according to the inventive principles of this patent disclosure, a portable player may include a control unit designed to perform an instant replay operation using instant replay data stored in a nonvolatile semiconductor memory during a cold boot operation. The control unit may be designed to perform the instant replay operation without accessing a mechanical mass storage device during the cold boot operation, and the instant replay data may be loaded from a volatile work memory to the nonvolatile semiconductor memory during a power-down conversion.

In another example embodiment according to the inventive principles of this patent disclosure, a portable player may include a control unit, a RAM controlled by the control unit, a hard disk drive controlled by the control unit to store replay data, and a NAND flash memory controlled by the control unit and including a boot code region where a boot code is stored, a code region where an application program is stored, and a playback buffer region. The playback buffer region of the NAND flash memory may store part of the replay data from the hard disk drive, and replay data stored in the playback buffer region may be loaded into the RAM for playback during a normal mode. Instant replay data stored in the RAM may be stored in the NAND flash memory together with flag information indicating whether data stored in the playback buffer region of the NAND flash memory is valid during a normal/slip to power-down conversion. Instant replay data stored in the NAND flash memory may be loaded into the RAM to perform an instant replay operation without an initialization operation of the hard disk drive during a cold boot operation, and it may include final replay data that was replayed before a power-down conversion.

Another example embodiment according to the inventive principles of this patent disclosure relates to a method for controlling a portable player including a hard disk drive for storing replay data, in which the method may include loading part of the replay data stored on the hard disk drive to a playback buffer region of a flash memory. Replay data from the playback buffer region may be loaded to a RAM to perform a replay operation during a normal mode. The method my further include storing instant replay data from the RAM in the flash memory, loading the instant replay data from the flash memory to the RAM during a cold boot operation, detecting whether replay data in the playback buffer region is valid, and performing an instant replay operation without initializing the hard disk drive if replay data in the playback buffer region is valid.

### BRIEF DESCRIPTION OF THE DRAWINGS

FIG. 1 is a schematic block diagram of a conventional digital audio/video player.

FIG. 2 is a flowchart illustrating an operation of the player shown in FIG. 1.

FIG. 3 is a schematic block diagram of a memory structure of the player shown in FIG. 1.

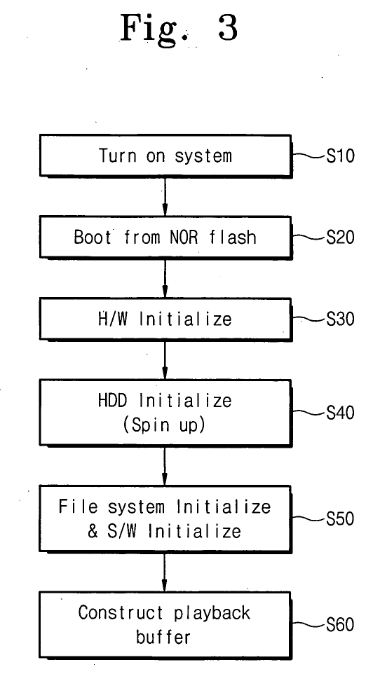

FIG. 4 is a schematic block diagram of an embodiment of a digital audio/video player according to the inventive principles of this patent disclosure.

FIG. 5 is a flowchart illustrating an embodiment of an operation of a player according to the inventive principles of this patent disclosure.

FIG. 6 is a schematic block diagram illustrating data flow during an embodiment of a cold boot operation according to the inventive principles of this patent disclosure.

FIG. 7 is a flowchart illustrating an embodiment of an instant replay operation according to the inventive principles of this patent disclosure.

FIG. 8 is a schematic block diagram of data flow during an embodiment of an instant replay operation according to the inventive principles of this patent disclosure.

FIG. 9 is a schematic block diagram of an embodiment of a memory structure according to the inventive principles of this patent disclosure.

FIG. 10 is a flowchart illustrating an embodiment of a process for initializing a hard disk drive during a replay operation according to the inventive principles of this patent disclosure.

### DETAILED DESCRIPTION

Example embodiments of a portable digital player are described below for purposes of illustrating the inventive principles of this patent disclosure. These principles may, however, be embodied in different forms and are limited to the embodiments set forth herein. Rather, these embodiments are provided to convey the inventive principles to those skilled in the art.

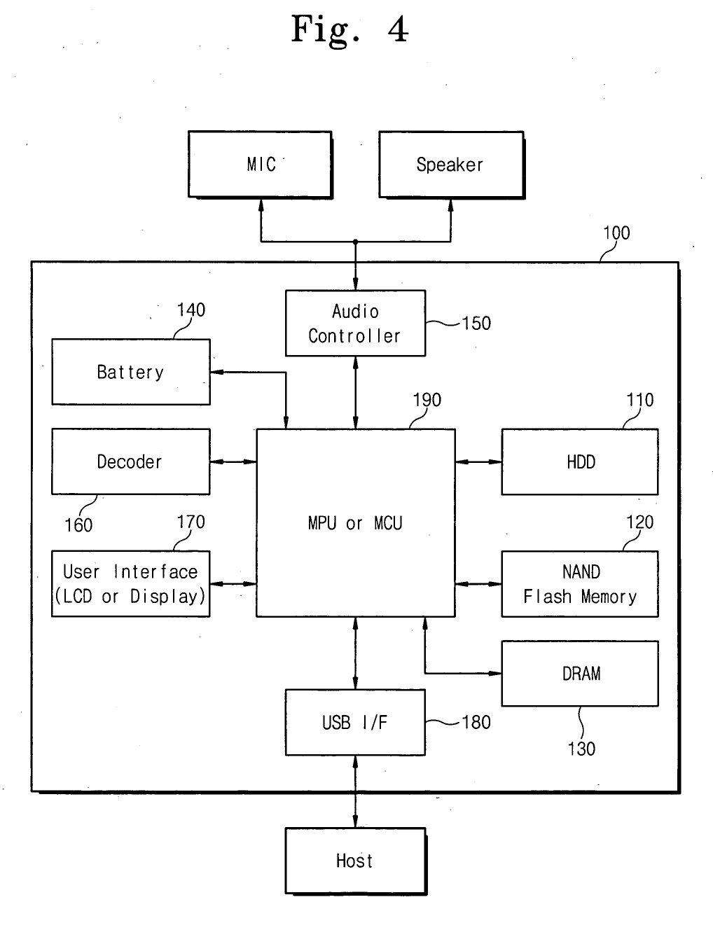

FIG. 4 is a schematic block diagram of a portable audio/video player according to the inventive principles of this patent disclosure.

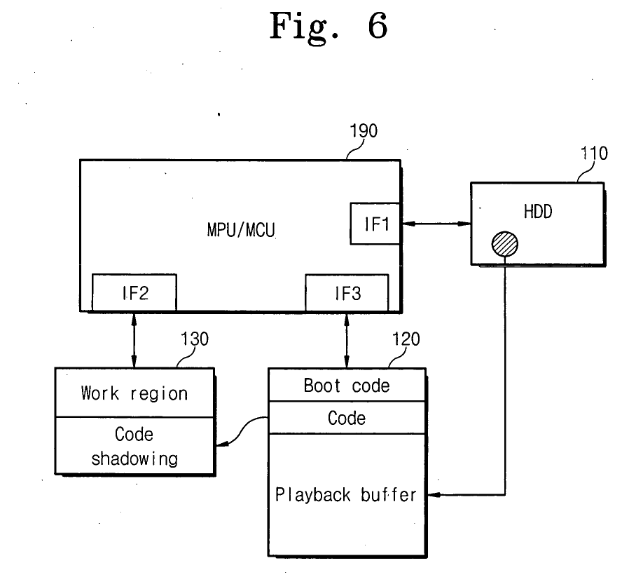

Referring to FIG. 4, the portable audio/video player 100 is based on a hard disk drive (HDD) and may include an MP3 player, a portable multimedia player (PMP) and so forth. Audio/video data (e.g., audio/video files) to be replayed is stored in a HDD 110. The player may further include a NAND flash memory 120 and a DRAM 130. The NAND flash memory 120 is used to store code such boot code and an application program. In addition, the NAND flash memory 120 may be structured to provide a playback buffer, and a code region for application programs such as a NAND flash driver, a flash file layer (FTL), a file replay program, and/or a playback buffer region (See FIG. 6). An application program stored in the code region of the NAND flash memory 120 may be run from the DRAM 130 employing a shadowing method. In addition, the player 100 may be driven by power supplied by an embedded battery 140, and may include an audio controller 150 connected to an external microphone and speaker, a decoder 160, a user interface 170 such as a display, and a USB interface 180 for interfacing with a host.

Since boot code and an application program may be stored in a NAND flash memory 120, a high-cost NOR-type flash memory is not needed. Also, it is possible to reduce the capacity of the DRAM from several tens of megabits (Mb) to just several Mb because the playback buffer stored not in the NAND flash memory 120 rather than the DRAM 130.

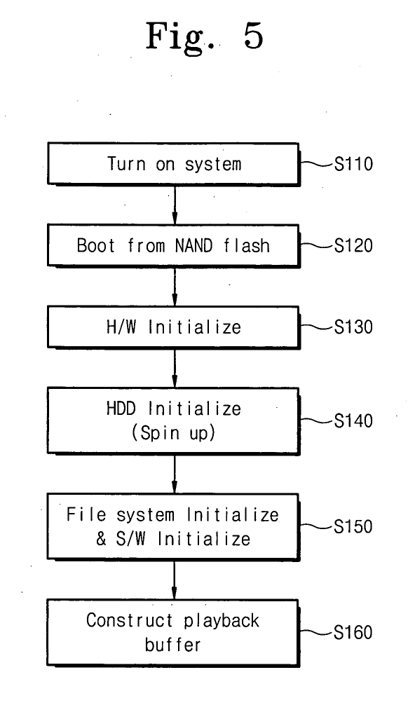

An example embodiment of an operating method for the player 100 will be described with reference to FIGS. 5 and 6. As shown in FIG. 6, the boot code and an application program may be stored in the NAND flash memory 120 instead of a NOR-type flash memory.

During power-up (S110), an MPU or MCU 190 performs a boot operation using boot code stored in the NAND flash memory 120 (S120). Then, a hardware initialization operation is performed under the control of the MPU or MCU 190 (S130). After the hardware initialization is completed, the HDD 100 is initialized (S140). That is, a spin-up operation is performed on the HDD 100. This state is called a “standby state.” In the next step (S150), a file system and a software initialization operation are performed. Finally, data to be replayed (e.g., data replayed previously or to be newly replayed) is loaded from the HDD 110 to the playback buffer region of the NAND flash memory 10 under the control of the MCU or MPU 190 (S160). That is, part of the data to be replayed may be stored in the playback buffer region.

In one embodiment, data stored in the playback buffer region of the NAND flash memory 120 may be subject to direct access by the DRAM 130. Rather than replaying data from the playback buffer region of the NAND flash memory, data (e.g., an audio/video data file) may be loaded to a work region of the DRAM 130 by a regular unit, and then replayed.

In a portable audio/video player 100 according to the inventive principles of this patent disclosure, an application program such as a replay program, as well as a driver for the NAND flash memory 120, may be stored in the code region of the NAND flash memory 120. This driver software may be a well-known file system (e.g., a flash translation layer (FTL)) or as simple driver for supporting simple erase, read, and/or write operations. The MCU/MPU 190 according to the inventive principles of this patent disclosure may include a NOR interface and a NAND interface so as to provide an interface with the NAND flash memory 130. The NAND flash memory 120 may be a standard NAND flash memory, or a NAND flash memory with a NOR interface such as Samsung's OneNAND® flash device.

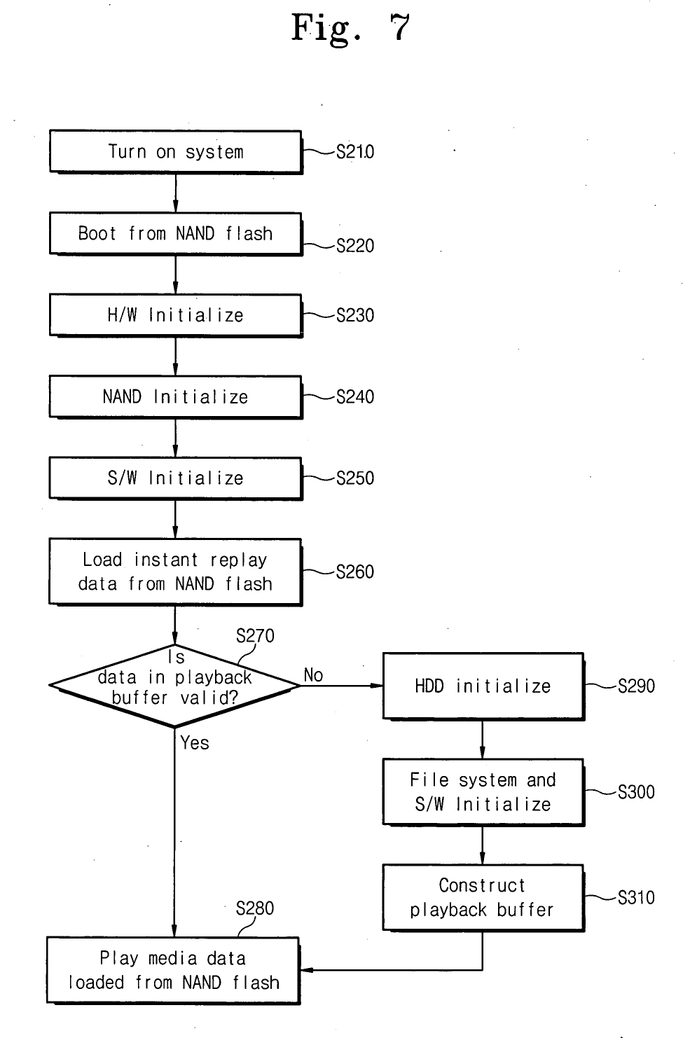

An embodiment of an instant replay operation of a portable audio/video player according to the inventive principles of this patent disclosure will be described with reference to FIGS. 7, 8 and 10.

In normal operation mode in which a replay operation is performed as described above, the player 100 enters slip mode if the replay operation stops for a predetermined time. During slip mode, power consumption from the battery 140 is minimized, e.g., power is supplied only to the DRAM 130, and power is interrupted to the other elements. But even if power is interrupted, data stored in the playback buffer region of the NAND flash memory 120 is maintained. If the user causes the player to transition from slip mode to the normal mode, replay operation resumes on the basis of data stored in the work region of the DRAM 130. That is, a warm boot operation is performed.

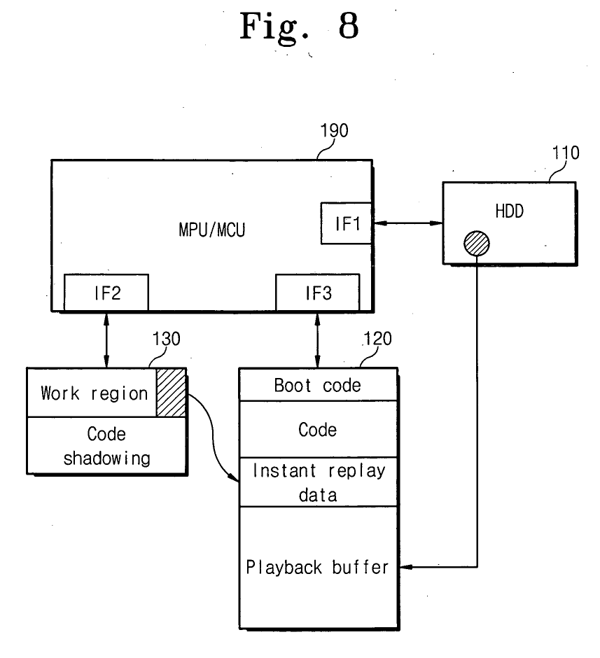

If there is no input during the slip mode after a predetermined time, the player 100 transitions from slip mode to power-down mode. Before entering power-down mode, replay information (hereinafter, referred to as “instant replay data”) stored in the work region of the DRAM 130, as shown in FIG. 8, is stored in the NAND flash memory 120 under the control of the MCU/MPU 190. Once the player 100 enters power-down mode, power consumption of the system is completely interrupted. Since power to the DRAM 130 is interrupted during power-down mode, all of information stored in the DRAM 130 is lost.

If a user turns the player off during normal mode, that is, the normal mode is directly switched to the power-down mode, the above-mentioned orderly shut-down process (i.e., a backup operation of instant replay data to the NAND flash memory) will be performed in the same manner. In contrast, if power is suddenly interrupted, the backup operation of the instant replay data may or may not secured.

In this embodiment, the instant replay data may include final replay data, as well as data before/after the final replay data.

If a power switch is turned on during power-down mode (or power is supplied from the battery 140) (S210), a boot operation is performed using boot code stored in the NAND flash memory 120 (S220). Next, a hardware initialization operation is performed under the control of the MPU or MCU 190 (S230). After completing the hardware initialization operation, the NAND flash memory 120 is initialized (S240). In accordance with the inventive principles of this patent disclosure, the spin-up operation is not performed during the power-down-to-normal mode conversion. At this time, an application program needed to replay audio/video data is shadowed to the DRAM 130. Then, the instant replay data stored in the NAND flash memory 120 is loaded to a work memory region of the DRAM 130.

After the load operation of the instant replay data to the DRAM 130 is performed, the MPU/MCU 190 detects whether the data stored in the playback buffer region of the NAND flash memory 120 is valid or not (S270). Various methods may be used to determine if the data is valid. For example, during a normal conversion to power-down mode, the MPU/MCU 190 may store instant replay information in the NAND flash memory together with flag information that indicates data stored in the playback buffer region is valid. The flag information will be accessed by the MPU/MCU 190 when the instant replay data is loaded to the DRAM 130 or before the instant replay data is loaded. In transitioning from power-down mode to normal operation mode, the MPU/MCU 190 may detect whether the data stored in the playback buffer region of the NAND flash memory 120 is valid on the basis of the flag information stored in the NAND flash memory 120. If the data stored in the playback buffer region of the NAND flash memory 120 is valid, media (or replay) data loaded from the playback buffer region of the NAND flash memory 120 is replayed normally. In other words, an instant replay operation is performed.

Returning to S270 step, if the data stored in the playback buffer region of the NAND flash memory 120 is not valid, the playback buffer should be configured again. This is performed in steps (S290) through (S310). In more detail, the HDD 110 is initialized at step (S290). That is, a spin-up operation is performed on the HDD 110. After a file system and a software initialization operation are performed (S300), data to be replayed is loaded into the playback buffer region of the NAND flash memory 120 under the control of the MCU/MPU 190 (S310). That is, part of data to be replayed is stored in the playback buffer region. Thereafter, a replay operation is performed as described above, that is, replay data is loaded from the playback buffer region of the NAND flash memory to the DRAM by a regular unit.

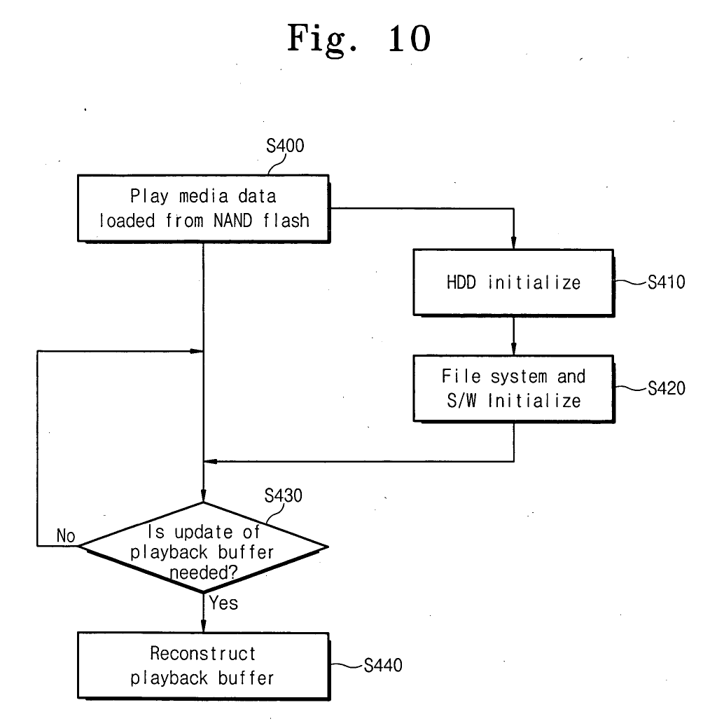

If a replay operation is performed without initializing the HDD, the HDD should be initialized so as to copy the next data to be replayed to the playback buffer region of the NAND flash memory 120. In this case, there is a possibility that the standby time for copying data to be replayed to the playback buffer region may increase. This may be compensated for by simultaneously initializing the HDD during a replay operation. That is, as shown in FIG. 10, when a replay operation is performed without initializing the HDD (S400), HDD initialization operation and the file system and SW initialization operations (S410 and S420) may be performed at the same time. Then, if there is a request to update the playback buffer of the NAND flash memory 120, media (or replay) data from the HDD 110 may be copied to the playback buffer region of the NAND flash memory 120 without delay or standby time (S440).

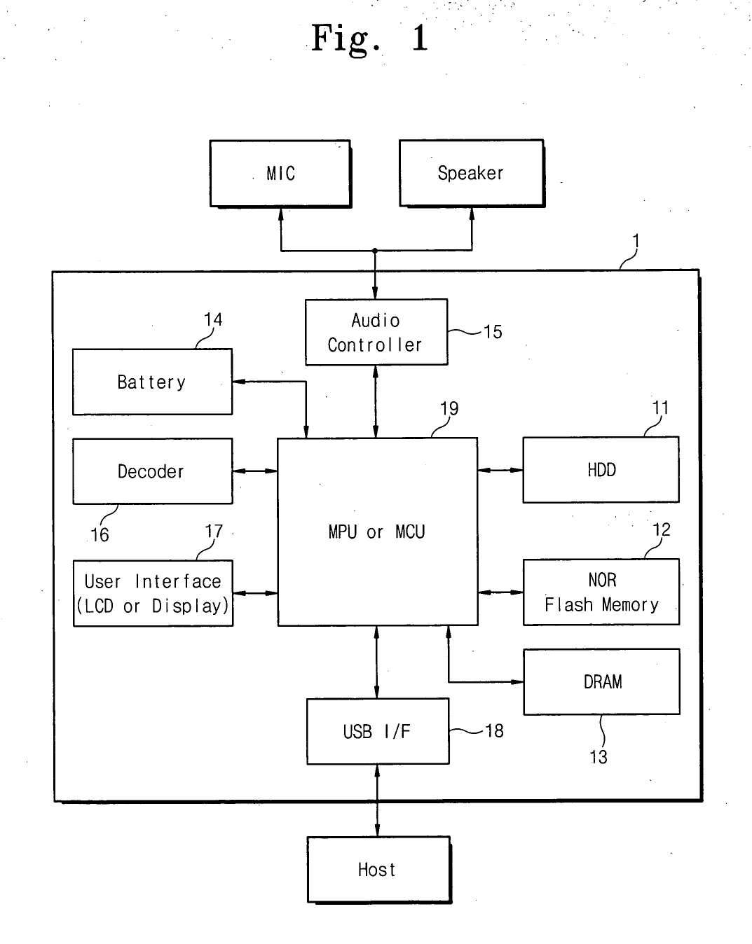

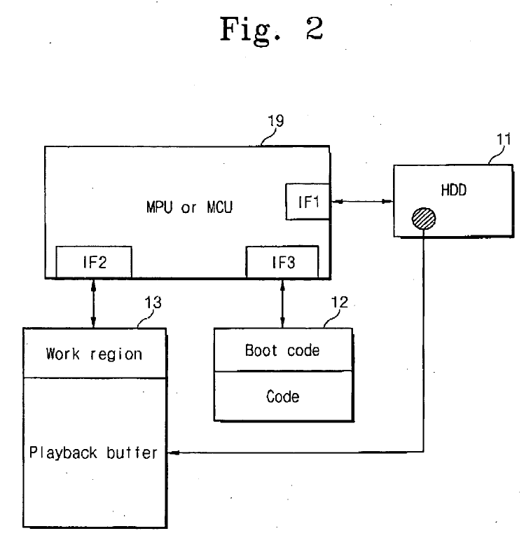

As previously mentioned, the cold boot operation of the player of FIG. 1 consumes considerable power and time because all information is lost in power-down mode. That is, all of the steps of FIG. 2 must be performed in converting from power-down mode to a normal operation mode. Also, the cold boot operation of FIG. 2 requires the HDD to spin-up and reconfiguration of the playback buffer. As a result, considerable power is consumed, and a long standby time is required for an instant replay operation.

Unlike the player 1 of FIG. 1, a player according to the inventive principles of this patent disclosure may not require a spin-up of the HDD and reconfiguration of the playback buffer during a cold boot operation for an instant replay. Thus, the cold boot operation according to the inventive principles of this patent disclosure may be performed in a short time, e.g., as much time as is required for a warm boot operation. In addition, since a player according to the inventive principles of this patent disclosure may not need a spin-up operation and reconfiguration of the playback buffer during a cold boot operation for an instant replay, it may be possible to reduce the power consumption required for the spin-up operation and the reconfiguration of the playback buffer. Thus a system may be driven, and at the same time, a replay operation may be performed.

Specifically, a cold boot operation according to the inventive principles of this patent disclosure may reduce power consumption considerably if a player changes modes frequently. That is, when mode conversions (e.g., power-down-to-normal conversion or normal-to power-down conversion) frequently happen, that is, the cold boot operation happens frequently, the spin-up operation of the HDD and the reconfiguration of the playback buffer may not be required. Thus, the power consumption of cold boot operations may be reduced, and therefore, replay time may be improved. This improvement in energy consumption for one possible example embodiment may be summarized in the following Table 1.

TABLE 1

| | Energy Consumption | | Energy Consumption | | |
|---|---|---|---|---|---|
| | according to | | according to | | |
| | a structure of | | a structure of | | Total |
| | HDD-DRAM base | | HDD-NAND base | | Energy |
| | HDD | DRAM | HDD | NAND | Saving |
| Succession Use | 226 | 42 | 264 | 3 | 1 |
| (14 Hours) | | | | | |
| 2 Hours Use | 226 | 490 | 264 | 3 | 49 |
| for a week | | | | | |
| everyday | | | | | |

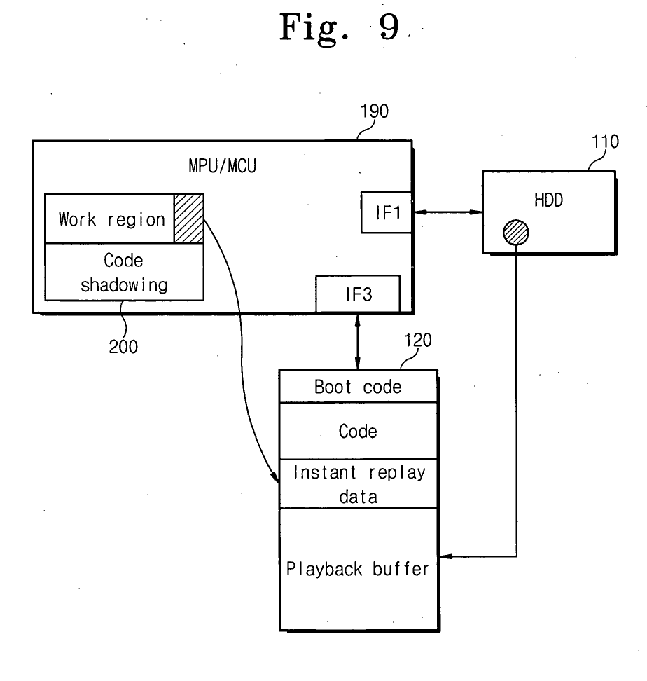

In another embodiment, the DRAM 130 may be replaced by an SRAM in the MCU/MPU 190, as shown in FIG. 9. This may be useful, for example, the application program and the capacity of the DRAM 130 used for work memory is not large. In this case, the SRAM 200 will be used as to perform the application program and/or as a work memory.

According to the inventive principles of this patent disclosure, it may be possible to reduce the unit cost of a player by removing a high-cost NOR-type flash memory and reducing a capacity of the DRAM. Also, a cold boot operation for an instant replay may be performed in a short time similar to that for a warm boot operation. Furthermore, since a spin-up operation and the reconfiguration of the playback buffer may not be required during a cold boot operation, power consumption may be reduced.

Although the inventive principles of this patent disclosure has been described in connection with the embodiments illustrated in the accompanying drawings, they not limited thereto. It will be apparent to those skilled in the art that various substitution, modifications and changes may be thereto while still falling within the scope of the following claims.

1. A portable player comprising:
a control unit;
a RAM controlled by the control unit;
a hard disk drive controlled by the control unit to store replay data; and
a NAND flash memory controlled by the control unit and including a boot code region where a boot code is stored, a code region where an application program is stored, and a playback buffer region;
wherein the playback buffer region of the NAND flash memory stores part of the replay data from the hard disk drive;
wherein replay data stored in the playback buffer region is loaded into the RAM for playback during a normal mode;
wherein instant replay data stored in the RAM is stored in the NAND flash memory together with flag information indicating whether data stored in the playback buffer region of the NAND flash memory is valid during a normal/slip to power-down conversion; and
wherein instant replay data stored in the NAND flash memory is loaded into the RAM to perform an instant replay operation without an initialization operation of the hard disk drive during a cold boot operation.

2. The portable player as set forth in claim 1, wherein the instant replay data includes final replay data that was replayed before a power-down conversion.

3. The portable player as set forth in claim 2, wherein the instant replay data includes either one of the final replay data and data from before and/or after the final replay data.

4. The portable player as set forth in claim 1, wherein the control unit detects whether replay data stored in the NAND flash memory is valid based on the flag information before the instant replay operation is performed.

5. The portable player as set forth in claim 4, wherein:
if the replay data stored in the NAND flash memory is valid, the instant replay operation is performed; and
if the replay data stored in the NAND flash memory is invalid, the control unit initializes the hard disk drive to load replay data to the playback buffer region of the NAND flash memory.

6. The portable player as set forth in claim 1, wherein the control unit initializes the hard disk drive while the instant replay operation is performed.

7. The portable player as set forth in claim 1, wherein the RAM is a DRAM.

8. The portable player as set forth in claim 1, wherein the RAM is an SRAM included in the control unit.

9. A method for controlling a portable player including a hard disk drive for storing replay data, the method comprising:
loading part of the replay data stored on the hard disk drive to a playback buffer region of a flash memory;
loading replay data from the playback buffer region to a RAM to perform a replay operation during a normal mode;
storing instant replay data from the RAM in the flash memory;
loading the instant replay data from the flash memory to the RAM during a cold boot operation;
detecting whether replay data in the playback buffer region is valid; and
performing an instant replay operation without initializing the hard disk drive if replay data in the playback buffer region is valid.

10. The method as set forth in claim 9, further comprising initializing the hard disk drive to load replay data to the playback buffer region of the flash memory if replay data stored in the flash memory is invalid.

11. The method as set forth in claim 9, further comprising initializing the hard disk drive during the instant replay operation.

12. The method as set forth in claim 11, further comprising reconstructing the playback buffer region if there is a request to update the playback buffer region.

13. The method as set forth in claim 9, wherein the instant replay data is stored from the RAM to the flash memory during a normal/slip to power-down conversion.

14. The method as set forth in claim 9, wherein the instant replay data is stored from the RAM to the flash memory along with flag information indicating whether replay data in the playback buffer region is valid.

15. The method as set forth in claim 9, wherein the instant replay data is loaded from the flash memory to the RAM during a cold boot operation if replay data in the playback buffer region is valid.

16. A portable player comprising:
a control unit;
a mechanical mass storage device coupled to the control unit to store replay data; and
a nonvolatile semiconductor memory coupled to the control unit to store instant replay data;
wherein the control unit is designed to perform an instant replay operation using the instant replay data in the nonvolatile semiconductor memory during a cold boot operation.

17. The portable player as set forth in claim 16, wherein the control unit is designed to perform the instant replay operation without accessing the mechanical mass storage device during the cold boot operation.

18. The portable player as set forth in claim 17, wherein flag information is stored in the nonvolatile semiconductor memory to indicate whether the instant replay data is valid.

19. The portable player as set forth in claim 17, further comprising a volatile memory including work memory coupled to the control unit.

20. The portable player as set forth in claim 19, wherein the instant replay data is loaded from the work memory to the nonvolatile semiconductor memory during a power-down conversion.

21. The portable player as set forth in claim 20, wherein the instant replay data is loaded from the nonvolatile semiconductor memory to the work memory during a cold boot operation.

22. The portable player as set forth in claim 21, wherein replay data from the mechanical mass storage device is loaded into the nonvolatile semiconductor memory for use during a normal mode.

23. The portable player as set forth in claim 22, wherein replay data from the nonvolatile semiconductor memory is loaded into the work memory for use during normal mode.
